(19) United States
(12) Patent Application Publication
(10) Pub. No.: US 2022/0103464 A1
(43) Pub. Date: Mar. 31, 2022

(54) CONTROL APPARATUS AND CONTROL METHOD

(71) Applicant: Nippon Telegraph and Telephone Corporation, Tokyo (JP)

(72) Inventors: Shingo OKADA, Tokyo (JP); Takuya TOJO, Tokyo (JP); Seisho YASUKAWA, Tokyo (JP)

(21) Appl. No.: 17/426,758

(22) PCT Filed: Jan. 22, 2020
(86) PCT No.: PCT/JP2020/002080

§ 371 Date: Jul. 29, 2021

(30) Foreign Application Priority Data
Jan. 29, 2019 (JP) 2019-013660

(51) Int. Cl. H04L 45/24; H04L 45/42; H04L 45/00; H04L 45/12; H04L 41/0654

(52) U.S. Cl. CPC H04L 45/24; H04L 45/42; H04L 41/0654; H04L 45/123; H04L 45/22

(57) ABSTRACT

A control device includes: a transmission configuration information storage unit configured to manage a transmission path that connects the plurality of transmission apparatuses to each other, and whether a redundant configuration in a transmission layer is available for the transmission path; a route information storage unit configured to manage a route configured between the plurality of routers and a transmission path used on the route; and a transfer path establishing unit configured to, in response to an establishment request including a requirement for the redundant configuration for a transfer path connecting the plurality of routers to each other, refer to the transmission configuration information storage unit and the route information storage unit, establish a transfer path using a redundant route when a redundant configuration in a transfer layer is required as the requirement in the redundant configuration, and establish a transfer path not using the redundant route but being linked to the transmission path with the redundant configuration in the transmission layer when the redundant configuration in the transmission layer is required as the requirement for the redundant configuration.

### TECHNICAL FIELD

The present invention relates to a control device and a control method.

### BACKGROUND ART

For networks in the 5G era, virtualization (NW slice) of carrier networks is an important factor. Furthermore, services need to be provided swiftly. In view of these, the networks need to be implemented using Software Defined. Network (SDN) technology. Furthermore, 5G is anticipated to enable various services such as Internet of Things (IoT), autonomous driving, and high resolution video streaming. Thus, with NW slices, networks with various requirements need to be established.

Meanwhile, implementation of various NW slices for 5G in a carrier network requires implementation of NW path, but this involves a task of integrated control for transmission layer/transfer layers (multilayer SDN control) for which management means have been under study by Open Source Software (OSS) projects such as Open Network Operating System (ONOS) and Open Network Automation Platform (ONAP) (see Non Patent Literatures 1 and 2).

### CITATION LIST

### Non Patent Literature

Non Patent Literature 1: ONOS, Internet <URL: https://onosproject.org/>, searched on Dec. 20, 2018

Non Patent Literature 2: ONAP, Internet <URL: https://www.onap.org/>, searched on Dec. 20, 2018

Non Patent Literature 3: NTT DOCOMO Technical Journal, Vol. 23, No. 4, pp. 76-77, Internet <URL:

https://www.nttdocomo.co.jp/binary/pdf/corporate/technology/rd/technical_journal/bn/vol23_4/vol23_4_000jp.pdf>, searched on Dec. 20, 2018

### SUMMARY OF THE INVENTION

### Technical Problem

For the sake of guaranteeing appropriate level of reliability and achieving cost reduction, 5G networks are anticipated to be designed with service requirement levels adjusted based on traffic characteristics and priorities of terminals and devices accommodated (see Non Patent Literature 3). For example, a NW use case may be defined for 5G such that extremely high reliability is not required unlike IoT and the like.

FIG. 1 illustrates a related-art network configuration. As illustrated in FIG. 1, the related-art network configuration has a transfer layer (L2/L3 device) and a transmission layer (L0/L1 device) separately configured. A known example of a transfer layer service is a Virtual Private Network (VPN) service. A known example of a transmission layer service is a wavelength occupying dedicated line service. In the related art, a redundant configuration can be configured for the VPN on the transfer layer only when the configuration can be installed in the transfer layer (such as transfer protection/no redundancy). Transmission restoration is known as a redundant configuration in the transmission layer. The redundant configuration in the transmission layer is inclusively applied to the entire underlay NW or is individually applied to each underlay NW path for establishing VPN in the transfer layer. As described above, the transfer layer and the redundant layer are managed separately from each other, and the redundant configuration of the path is also achieved in each of the layers, meaning that the redundant configuration in the transmission layer cannot be configured for each VPN of the transfer layer. As a result, various requirements regarding reliability anticipated in 5G NW use cases may fail to be satisfied.

An object of the present invention is to provide a transfer path that satisfies more reliability requirements by enabling a redundant configuration in a transmission layer to be applicable to a transfer path in a transfer layer.

### Means for Solving the Problem

A control device according to an aspect of the present invention is a control device used in a communication network including a plurality of routers and a plurality of transmission apparatuses configured to connect the plurality of routers to each other, the control device including: a transmission configuration information storage unit configured to manage a transmission path that connects the plurality of transmission apparatuses to each other, and whether a redundant configuration in a transmission layer is available for the transmission path; a route information storage unit configured to manage a route configured between the plurality of routers and a transmission path used on the route; and a transfer path establishing unit configured to, in response to an establishment request including a requirement for the redundant configuration for a transfer path connecting the plurality of routers to each other, refer to the transmission configuration information storage unit and the route information storage unit, establish a transfer path using a redundant route when a redundant configuration in a transfer layer is required as the requirement in the redundant configuration, and establish a transfer path not using the redundant route but being linked to the transmission path with the redundant configuration in the transmission layer when the redundant configuration in the transmission layer is required as the requirement for the redundant configuration.

A control method according to an aspect of the present invention is a control method performed by a control device used in a communication network including a plurality of routers and a plurality of transmission apparatuses configured to connect to plurality of routers to each other, the control method including: managing, in a transmission configuration information storage unit, a transmission path that connects the plurality of transmission apparatuses to each other, and whether a redundant configuration in a transmission layer is available for the transmission path; managing, in a route information storage unit, a route configured between the routers and a transmission path used on the route; and in response to an establishment request including a requirement for the redundant configuration for a transfer path connecting the plurality of routers to each other, referring to the transmission configuration information storage unit and the route information storage unit, establishing a transfer path using a redundant route when a redundant configuration in a transfer layer is required as the requirement in the redundant configuration, and establishing a transfer path not using the redundant route but being linked to the transmission path with the redundant configuration in the transmission layer when the redundant configuration in the transmission layer is required as the requirement for the redundant configuration.

### Effects of the Invention

With the present invention, a redundant configuration in a transmission layer is applicable to a transfer path in a transfer layer, whereby a transfer path can be provided that satisfies more reliability requirements.

### BRIEF DESCRIPTION OF DRAWINGS

FIG. 1 is a diagram illustrating a related-art network configuration.

FIG. 2 is a diagram illustrating an overall configuration of an IP/transmission network according to an embodiment of the present invention.

FIG. 3 is a diagram illustrating an example of a physical connection configuration of an apparatus and an example of a configuration of a light wavelength.

FIG. 4 is a diagram illustrating an example of routing between routers.

FIG. 5 is a diagram illustrating a network configuration according to an embodiment of the present invention.

FIG. 6 is a block diagram illustrating a configuration of an SDN controller/NMS according to a first embodiment of the present invention.

FIG. 7 illustrates an example of transfer path information held in a transfer path information DB.

FIG. 8 illustrates an example of route information held in a route information DB.

FIG. 9 illustrates an example of transmission configuration information held in a transmission configuration information DB.

FIG. 10 illustrates an example of transmission restoration bypass route information held in a transmission restoration bypass route information DB.

FIG. 11 is a diagram illustrating an overall configuration of an IP/transmission network according to a second embodiment of the present invention.

FIG. 12 is a diagram illustrating an example of a configuration of a transmission path according to the second embodiment of the present invention.

FIG. 13 is a diagram illustrating an example of a configuration of a transfer path according to the second embodiment of the present invention.

FIG. 14 is a block diagram illustrating a configuration of an SDN controller/NMS according to the second embodiment of the present invention.

FIG. 15 illustrates an example of transmission path information held in a transmission path information DB.

FIG. 16 illustrates an example of user connection information held in a user connection information DB.

FIG. 17 illustrates an example of L2 switch connection information held in an L2 switch connection information DB.

FIG. 18 illustrates a hardware configuration example of the SDN controller/NMS according to the embodiment of the present invention.

### DESCRIPTION OF EMBODIMENTS

Hereinafter, an embodiment of the present invention will be described with reference to the drawings.

In embodiments of the present invention, a control device that enables a redundant configuration in a transmission layer to be applied to a transfer path in a transfer layer will be described.

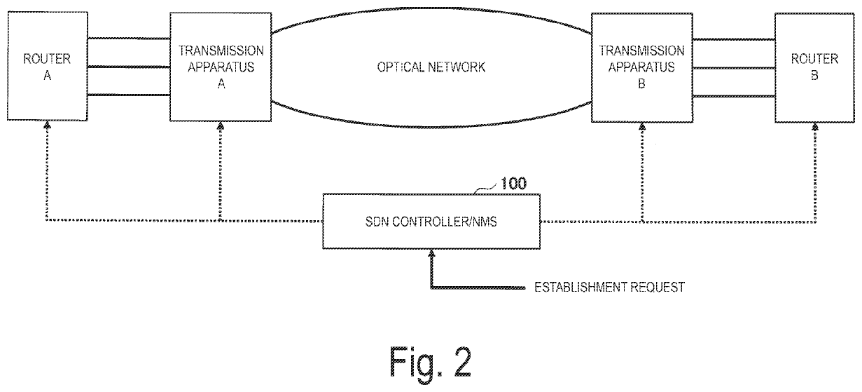

FIG. 2 illustrates a configuration of an Internet Protocol (IP)/transmission network according to an embodiment of the present invention. As illustrated in FIG. 2, the IP/transmission network includes routers A and B and transmission apparatuses A and B. The transmission apparatuses A and B form a network (hereinafter, referred to as an optical network) of the transmission layer. An IP network in a transfer layer is formed by connecting the routers A and B to the optical network. A Software Defined Network (SDN) controller/Network Management System (NMS) 100 is an example of a control device that controls routers and transmission apparatuses. In the present embodiment, the control device that controls routers and transmission apparatuses is referred to as the SDN controller/NMS 100. It should be noted that the SDN controller/NMS 100 may be a control device having functions of both of an SDN controller and an NMS, a control device having the function of the SDN controller only, a control device having the function of the NMS only, or a control device that is different and independent from the SDN controller or the NMS. Note that although two routers and two transmission apparatuses are illustrated in FIG. 2, the IP/transmission network may be configured with any number of routers and transmission apparatuses.

The optical network is configured under an assumption that a transmission apparatus such as a colorless, directionless and contentionless-reconfigurable optical add/drop multiplexer (CDC-ROADM) with which the wavelength of a light wavelength path can be changed is used. Still, the present embodiment can be applied to a configuration where locations are in 1 to 1 connection using only a transponder, as long as the wavelength of a light wavelength path can be dynamically changed. The router is a router that is capable of routing by using Segment Routing and the like. Still, the present embodiment can be applied to a case where Multi-Protocol Label Switching (MLS) or IP routing is used, as long as routing is available.

The routers and transmission apparatuses are assumed to be capable of establishing a transfer path and a transmission path satisfying a condition in a path establishment request received by the SDN controller/NMS 100. The transfer path is a path configured in the transfer layer. An example of a service using the transfer path includes a VPN service. The transmission path is a path configured in the transmission layer. An example of a service using the transmission path includes a wavelength occupying dedicated line service. In the following description, the transfer path used in the VPN service is simply referred to as VPN. The transmission path used in the wavelength occupying dedicated line service is referred to as a light wavelength path. The transmission path establishment request includes a requirement for a redundant configuration. The present embodiment is not limited to the direct control by the SDN controller/NMS 100, and can be applied to a configuration using an autonomous decentralized protocol between apparatuses, as long as a path satisfying the required condition (redundant configuration) can be configured.

Physical wiring information and port information between the routers and the transmission apparatuses described below are assumed to be registered in the SDN controller/NMS 100.

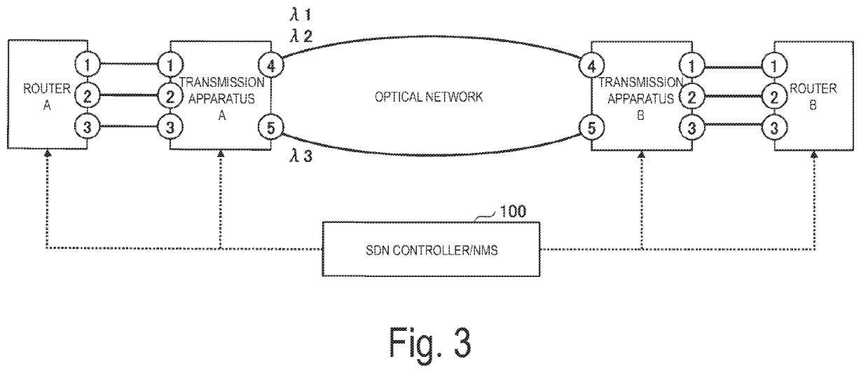

FIG. 3 illustrates an example of a physical connection configuration of an apparatus and an example of a configuration of a light wavelength. A light wavelength path is configured between the transmission apparatuses, and the routers communicate with each other by using the light wavelength path between the transmission apparatuses. Transmission restoration that is a redundant configuration in the transmission layer can be configured for the light wavelength path. In an example, a light wavelength path (light wavelength path ID=1) using a wavelength λ1 for which the transmission restoration is configured is assumed to be configured between a physical port 4 of the transmission apparatus A and a physical port 4 of the transmission apparatus B. Furthermore, a light wavelength path (light wavelength path ID=2) using a wavelength λ2 for which the transmission restoration is not configured is assumed to be configured between the physical port 4 of the transmission apparatus A and the physical port 4 of the transmission apparatus B. A light wavelength path (light wavelength path ID=3) using a wavelength λ3 for which the transmission restoration is not configured is assumed to be configured between a physical port 5 of the transmission apparatus A and the physical port 5 of the transmission apparatus B.

For the light wavelength path (light wavelength path ID=1) that is the target of the transmission restoration control, when the light wavelength path is disconnected due to a failure that has occurred between the physical port 4 of the transmission apparatus A and the physical port 4 of the transmission apparatus B, the SDN controller/NMS 100 switches the route to a bypass route between the physical port 5 of the transmission apparatus A and the physical port 5 of the transmission apparatus B to restore the light wavelength path. For the light wavelength paths (light wavelength paths ID=2 and 3) that are not the target of the transmission restoration control, even when the light wavelength path is disconnected, the SDN controller/NMS 100 does not perform this bypass control. The bypass route used for the transmission restoration by the SDN controller/NMS 100 may be set statically, or an available route may be automatically calculated by the SDN controller/NMS 100.

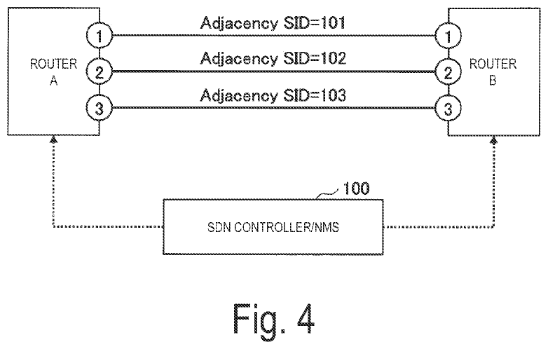

FIG. 4 illustrates an example of routing between routers. A plurality of routes is assumed to be configurable between the routers, and a route usable between the routers is assumed to be selectable with an instruction from the SDN controller/NMS 100. As one example, the routers A and B are assumed to be connected to each other through three routes as illustrated in FIG. 4, and any one of the routes are selectable with an instruction from the SDN controller/NMS 100. For example, when Segment Routing is used, Segment ID (SID) used in the Segment Routing is configured for a link as an Adjacency SID, and the SDN controller/NMS 100 uses the SID to designate the route used by Label Switched Path (LSP), so that a communication route can be controlled for each VPN. The SID can be configured for the router using a standard protocol such as a Network Configuration Protocol (NETCONF)/Yet Another Next Generation (YANG), and Path Computation Element Protocol (PCEP) or using Command Line Interface (CLI).

The SDN controller/NMS 100 is assumed to be aware of which of the light wavelength paths (the light wavelength path IDs=1, 2, and 3 in FIG. 3) between the transmission apparatuses has the route between the routers (Adjacency SIDs=101, 102, and 103 in FIG. 4) established thereon. Furthermore, the SDN controller/NMS 100 is assumed to be capable of setting which of the routes between the routers is used, based on a requirement related to whether the redundant configuration (restoration) in the transmission layer is enabled, when establishing the transfer path (VPN) in the transfer layer.

For example, a route with Adjacency SID=101 is established on the light wavelength path (light wavelength path ID=1) that is the target of the transmission restoration control. A route with Adjacency SID=102 is established on the light wavelength path (light wavelength path ID=2) that is not the target of the transmission restoration control. A route with Adjacency SID=103 is established on the light wavelength path (light wavelength path ID=3) that is not the target of the transmission restoration control. This relationship is managed by the SDN controller/NMS 100.

The SDN controller/NMS 100 is aware of the route of the transfer layer, and thus can configure transfer protection that is a redundant configuration in the transmission layer, by using the two routes (Adjacency SIDs=102 and 103) in the transfer layer as the transfer path.

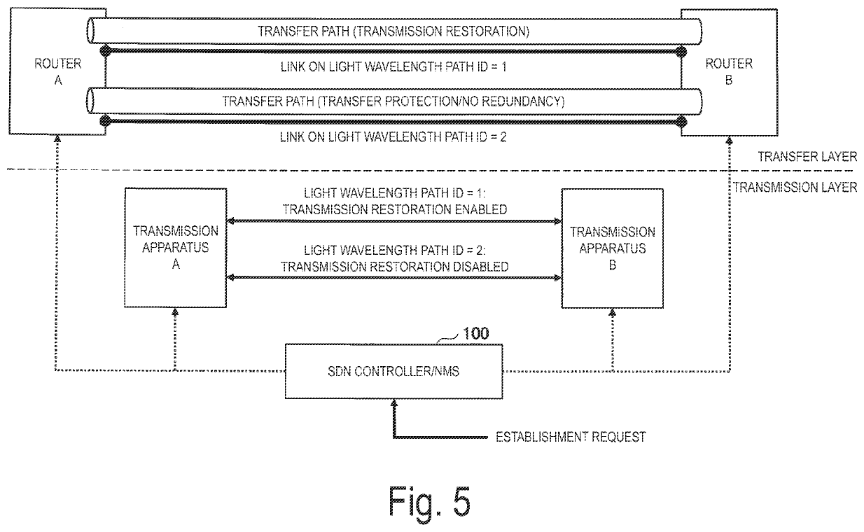

FIG. 5 illustrates a network configuration according to the embodiment of the present invention illustrated in FIGS. 2 to 4. As described above, the SDN controller/NMS 100 controls the entire system including the transmission layer and the transfer layer. The SDN controller/NMS 100 receives an establishment request for the transfer path, and configures a transfer path (VPN) that satisfies the redundancy requirement required in the establishment request.

For example, when the transfer protection is required in the transfer path establishment request, the transmission restoration is not required, and thus the transmission path (light wavelength path ID=2) for which the transmission restoration is not configured is used. Then, the transfer path for which the transfer protection is configured in the transfer layer is established on this transmission path.

For example, when the transmission restoration is required in the transfer path establishment request, the transmission path (light wavelength path ID=1) for which the transmission restoration is configured is used. Since the transfer protection is not required in this case, a path with no redundancy in the transfer layer is established on this transmission path.

For example, when the redundant configuration is not required in the transfer path establishment request, the transmission restoration is not required, and thus the transmission path (light wavelength pass ID=2) for which the transmission restoration is not configured is used. Since the transfer protection is also not required, a path with no redundancy in the transfer layer is established on this transmission path.

In this manner, the SDN controller/NMS 100 not only manages the redundant configuration in the transfer layer, but also manages the redundant configuration in the transmission layer. Thus, the SDN controller/NMS 100 identifies the redundant configuration in the transmission layer available for each route of an underlay NW for establishing the transfer path, and establishes the transfer path on the route satisfying the requirement in the transfer path establishment request. As in the above example, the SDN controller/NMS 100 can configure a plurality of redundant configurations (transfer protection, transmission restoration, no redundancy) for the transfer path.

Hereinafter, embodiments of the present invention will be further described in detail.

### First Embodiment

In the first embodiment, a method of configuring a redundant configuration of a transmission layer when establishing a path in a transfer layer will be described. The description of the present embodiment will be given under an assumption that, as described with reference to FIG. 3, in a segment between the transmission apparatus A and the transmission apparatus B, the light wavelength path ID=1 using the wavelength λ1 is the target of the transmission restoration control, and the light wavelength paths ID=2 and 3 using the wavelengths λ2 and λ3 respectively are not the target of the transmission restoration control.

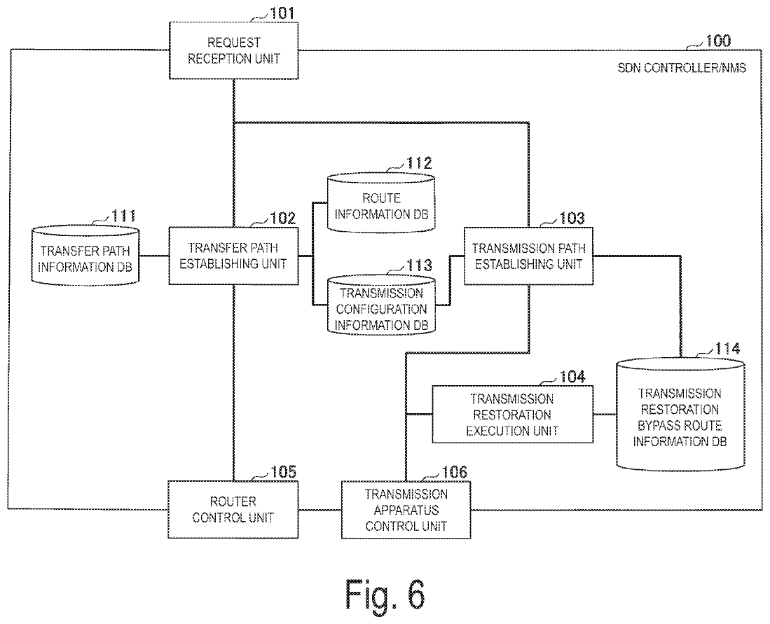

FIG. 6 is a block diagram illustrating a configuration of an SDN controller/NMS 100 according to the first embodiment of the present invention. The SDN controller/NMS 100 includes, as functional units, a request reception unit 101, a transfer path establishing unit 102, a transmission path establishing unit 103, a transmission restoration execution unit 104, a router control unit 105, and a transmission apparatus control unit 106. The SDN controller/NMS 100 further includes, as storage units, a transfer path information DB 111, a route information DB 112, a transmission configuration information DB 113, and a transmission restoration bypass route information DB 114.

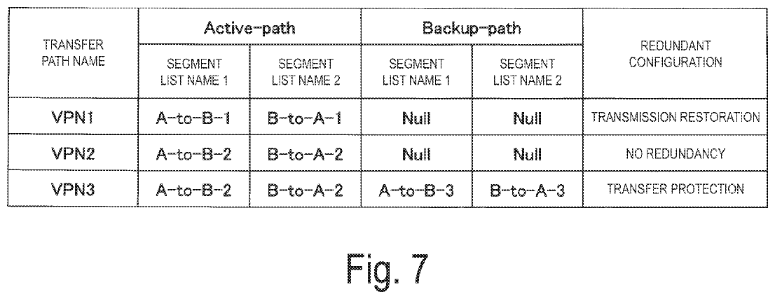

The transfer path information DB 111 is a storage unit that manages association between a transfer path (VPN), a route (Segment list), and a redundant configuration, configured between routers. In the transfer path information DB 111, information on a transfer path established by the transfer path establishing unit 102 as described later is registered. For example, in the example illustrated in FIG. 4, when a transfer path VPN1 configured for which the transmission restoration is configured using a route Adjacency SID=101 between the routers A and B is established, the transfer path information DB 111 holds information as illustrated in the first row in FIG. 7. Note that with Segment Routing, a route is designated for one direction at a time. Thus, one se of two routes is used for a bidirectional communication service. Thus, the transfer path information DB 111 holds two routes for each bidirectional communication service.

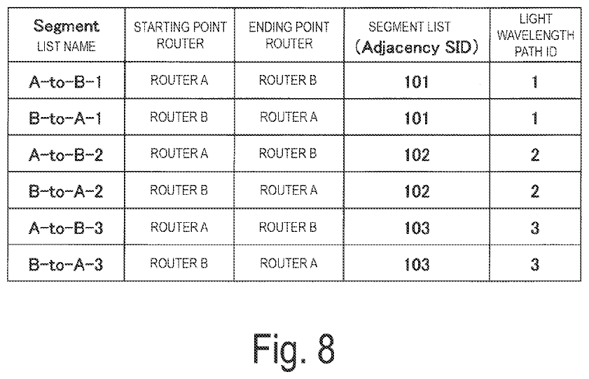

The route information DB 112 is a storage unit that manages association between the route (Segment list) configured between the routers and a light wavelength path used by the route. For example, in the example illustrated in FIGS. 3 and 4, when Adjacency SID=101 is configured on the light wavelength path ID=1 between the transmission apparatuses A and B, the route information DB 112 holds a starting point router, an ending point router, Segment list, and a wavelength path ID as illustrated in the first and second rows in FIG. 8. Also in this case, with Segment Routing, a route is designated for one direction at a time. Thus, one set of two routes is used for a bidirectional communication service. Thus, the route information DB 112 holds routes for both directions. FIG. 8 illustrates a case in which the Segment list includes a single segment. Note that the Segment list includes a plurality of SIDs if there are a plurality of segments between the routers.

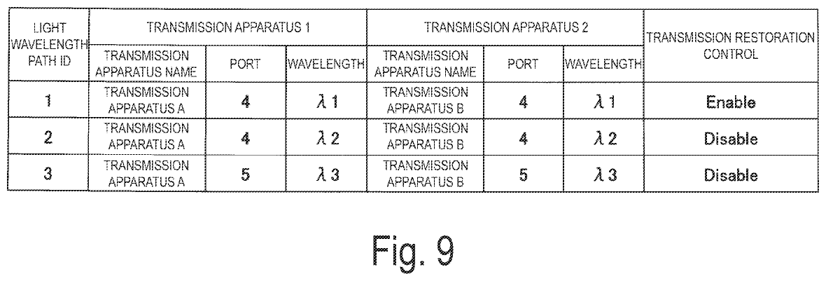

The transmission configuration information DB 113 is a storage unit that manages information on a light wavelength path configured between the transmission apparatuses. For example, the transmission configuration information DB 113 holds connection information on the physical configuration as illustrated in FIG. 3 in a format as illustrated in FIG. 9. Specifically, for each light wavelength path, the transmission apparatuses on both ends, port, wavelength, and whether redundant configuration (transmission restoration control) is enabled are held.

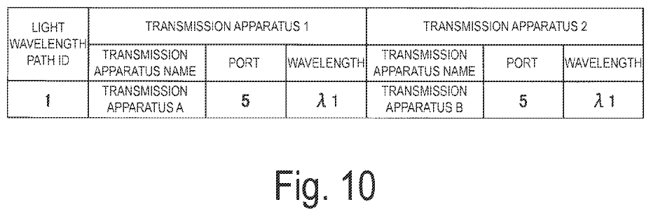

The transmission restoration bypass route information DB 114 is a storage unit that manages bypass route information for transmission restoration control. For example, the transmission restoration bypass route information DB 114 holds bypass route information indicating that, as illustrated in FIG. 3, the route of the light wavelength path ID=1 with the wavelength λ1 is switched to the bypass route between the physical ports 5, in a format illustrated in FIG. 10.

The request reception unit 101 receives an establishment request including a requirement for a redundant configuration (transfer protection/transmission restoration/no redundancy) for a transfer path (VPN). The establishment request further includes a starting point and an ending point of the transfer path. The request may be issued from the outside of the SDN controller/NMS 100 or may be a request as a result of calculation by an algorithm configured in the SDN controller/NMS 100 in advance.

In response to the establishment request, the transfer path establishing unit 102 searches the route information DB 112 for a route with which the redundant configuration in the transfer path establishment request can be implemented, and searches the transmission configuration information DB 113 for a route with which the redundant configuration in the establishment request can be implemented.

When the transmission restoration is required as a requirement for a redundant configuration for establishing the transfer path (VPN1), the transfer path establishing unit 102 needs to establish a transfer path without a redundant configuration that is linked with a transmission path for which the transmission restoration is configured. Specifically, the transfer path establishing unit 102 first searches the transmission configuration information DB 113 for the wavelength (λ1) for which the transmission restoration is enabled. Next, the transfer path establishing unit 102 searches the route information DB 112 for a Segment list name using the wavelength (λ1) for which the transmission restoration is enabled and having the starting point/ending point matching those of the transfer path requested. When there are a plurality of available Segment list names, the shortest path may be dynamically detected, dynamic determination using a certain weighting algorithm may be made, or static determination may be made through a selection by an operator. With Segment Routing, a route is designated for one direction at a time. Thus, one set of two routes is used for a bidirectional communication service. This means that two routes including one from the starting point to the ending point and one from the ending point to the starting point need to be extracted. Transfer path information as illustrated in the first row of FIG. 7 is generated based on the information extracted in this way. In the case of transmission restoration, the transfer protection is not configured, and thus Backup-path is set to be Null.

The transfer path establishing unit 102 registers the information in the transfer path information DB 111, and configures the transfer path (VPN1) for the routers at the starting point and the ending point via the router control unit 105. The configuration may be input to the router using an open Application Programming Interface (API) such as Netconf, or using a protocol unique to the router.

When no redundancy is required as a requirement for a redundant configuration for establishing the transfer path (VPN2), the transfer path establishing unit 102 needs to establish a transfer path without a redundant configuration that is linked with a transmission path for which the transmission restoration is not configured. Specifically, the transfer path establishing unit 102 first searches the transmission configuration information DB 113 for the wavelength (λ2, λ3) for which the transmission restoration is disabled. Next, the transfer path establishing unit 102 searches the route information DB 112 for a Segment list name using the wavelength (λ2, λ3) for which the transmission restoration is disabled and has the starting point/ending point matching those of the transfer path requested. When there are a plurality of available Segment list names, the shortest path may be dynamically detected, dynamic determination using a certain weighting algorithm may be made, or static determination may be made through a selection by an operator. With Segment Routing, a route is designated for one direction at a time. Thus, one set of two routes is used for a bidirectional communication service. This means that two routes including one from the starting point to the ending point and one from the ending point to the starting point need to be extracted. Transfer path information as illustrated in the second row of FIG. 7 is generated based on the information extracted in this way. In the case of no redundancy, the transfer protection is not configured, and thus Backup-path is set to be Null.

The transfer path establishing unit 102 registers the information in the transfer path information DB 111, and configures the transfer path (VPN2) for the routers at the starting point and the ending point via the router control unit 105.

When transfer protection is required as a requirement for a redundant configuration for establishing the transfer path (VPN3), the transfer path establishing unit 102 needs to establish a transfer path with a redundant configuration that is linked with a transmission path for Which the transmission restoration is configured. Specifically, the transfer path establishing unit 102 first searches the transmission configuration information DB 113 for the wavelength (λ2, λ3) for which the transmission restoration is disabled. Next, the transfer path establishing unit 102 searches the route information DB 112 for a Segment list name using the wavelength (λ2, λ3) for which the transmission restoration is disabled and has the starting point/ending point matching those of the transfer path requested. In this case, there needs to be available Segment list names for two routes, that is, for Active-Path and Backup-Path. When there are two or more routes, the shortest path may be dynamically detected, dynamic determination using a certain weighting algorithm may be used, or static determination may be made through a selection by an operator. Which of the two routes determined is to be Active-Path may similarly be determined. With Segment Routing, a route is designated for one direction at a time. Thus, one set of two routes is used for a bidirectional communication service. This means that two routes including one from the starting point to the ending point and one from the ending point to the starting point need to be extracted. Transfer path information as illustrated in the third row of FIG. 7 is generated based on the information extracted in this way. In the case of transfer protection, Backup-path is one of the routes that was not selected to be Active-Path.

The transfer path establishing unit 102 registers the information in the transfer path information DB 111, and configures the transfer path (VPN3) for the routers at the starting point and the ending point via the router control unit 105.

Note that in a case where there is no transmission path that satisfies the requirement for the redundant configuration in the transmission layer in the transmission configuration information DB 113, the transfer path establishing unit 102 requests the transmission path establishing unit 103 to establish the transmission path. For example, when the transfer path establishing unit 102 fails to find the wavelength for which the transmission restoration is enabled in the transmission configuration information DB 113, the transfer path establishing unit 102 requests the transmission path establishing unit 103 for establishing the transmission path for which the transmission restoration is configured.

The transmission path establishing unit 103 establishes the transmission path, and registers the information on the transmission path thus established, in the transmission configuration DB 113. When the transmission restoration is required as the requirement for the redundant configuration of the transmission path, the transmission path establishing unit 103 registers the transmission path for which the transmission restoration control is enabled when registering the information in the transmission configuration information DB 113 in FIG. 9. When the transmission restoration is not required as the requirement for the redundant configuration of the transmission path, the transmission path establishing unit 103 registers the transmission path for which the transmission restoration control is disabled when registering the information in the transmission configuration information DB 113 in FIG. 9. The ports or wavelengths used may be registered manually by the operator or may be automatically assigned from information on other resource pools and the like. The transmission path establishing unit 103 registers the information in the transmission configuration information DB 113, and inputs the configuration to the transmission apparatuses via, the transmission apparatus control unit 106 to establish the transmission path. The configuration may be input to the transmission apparatuses using an open API such as Netconf or using a protocol unique to the transmission apparatuses.

Upon receiving a port down alert from a transmission apparatus due to a failure that has occurred between the transmission apparatuses, the transmission restoration execution unit 104 searches the transmission configuration information DB 113 for a wavelength using the port for which the alert has been received, and identifies the wavelength. For example, when a failure occurs between the physical port 4 of the transmission apparatus A and the physical port 4 of the transmission apparatus B, the wavelength (λ1, λ2) utilizing the physical port 4 of the transmission apparatus A and the physical port 4 of the transmission apparatus B is extracted from the transmission configuration information DB 113. The route of the wavelength λ2 is not switched to the bypass route because transmission restoration control is disabled. The transmission restoration execution unit 104 extracts the light wavelength path ID=1 corresponding to the wavelength (λ1) for which the restoration control is enabled from the extracted wavelengths, and searches the transmission restoration bypass route information DB 114 in FIG. 10 for the bypass route. Based on this information, the transmission restoration execution unit 104 causes the transmission apparatus control unit 106 to control the transmission apparatuses and perform dynamic restoration with the bypass route. In the above example, the route of the light wavelength path for the wavelength λ1 is switched to a bypass route between the physical port 5 of the transmission apparatus A and the physical port 5 of the transmission apparatus B.

The SDN controller/NMS 100 thus collectively holding information on multilayers (transmission layer and transfer layer), can configure the redundant configuration in the transmission layer for the path in the transfer layer. In particular, in a network in which the SDN controller/NMS 100 controls the router and the transmission apparatuses, when establishing the transfer path (L2VPN/L3VPN) in response to the establishment request, the SDN controller/NMS 100 checks which redundant configuration (transmission restoration/no redundancy) is used by a link between the routers that will be the route of the transfer path, and determines the route of the transfer path. With this configuration, the SDN controller/NMS 100 can not only configure the redundant configuration (transfer protection/no redundancy) implemented in the transfer layer as the redundant configuration for the transfer path, but can also configure the redundant configuration (redundant protection) implemented on the transmission layer.

### Second Embodiment

A method described in a second embodiment makes a network path (transmission path (light wavelength path) or a transfer path (VPN)) available to a user with a plurality of redundant configurations, based on the above described concept in which the SDN controller/NMS 100 controls the entire system including the transmission layer and the transfer layer.

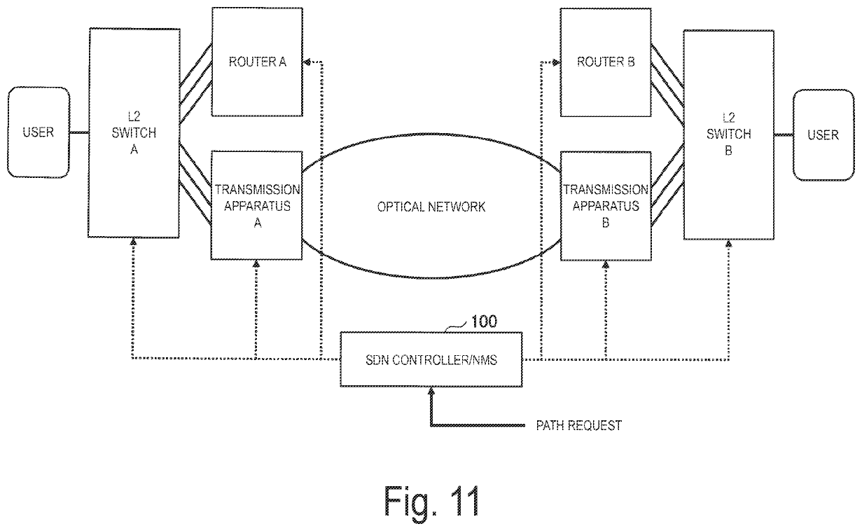

In a configuration according to the second embodiment, an L2 switch is connected to each of a user, a router, and a transmission apparatus as illustrated in FIG. 11, instead of direct connection between the router and the transmission apparatus as illustrated in FIG. 2. With the method provided, the L2 switch is used as a connection point between the user and the network path, and the network path is established to reach a connection port of the user in response to a path establishment request. In the present embodiment, an end point of the network path is a port of the L2 switch to which the router or the transmission apparatus is connected, and the connection point of the user is a port of the same L2 switch.

FIG. 11 is a diagram illustrating an overall configuration of an IP/transmission network according to the second embodiment of the present invention. As illustrated in FIG. 11, routers A and B and transmission apparatuses A and B are used for connecting an L2 switch A and an L2 switch B to which users are connected, to each other. Note that although two routers and two transmission apparatuses are illustrated in FIG. 11, the IP/transmission network may be configured with any number of routers and transmission apparatuses. The present embodiment is applicable even when an optical network connection configuration or the like changes, as long as the configuration has the L2 switch is connected to the user/router/transmission apparatus.

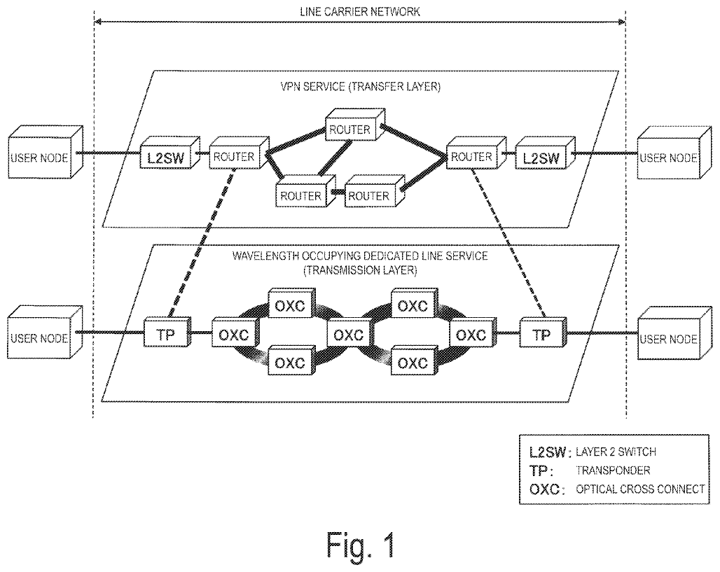

The user is connected to the router and the transmission apparatus via the L2 switch, and thus can make available the transmission path for which the transmission restoration is configured and make available the transfer path utilizing the transfer protection from the same end point (L2 switch), unlike in the related art network configuration illustrated in FIG. 1.

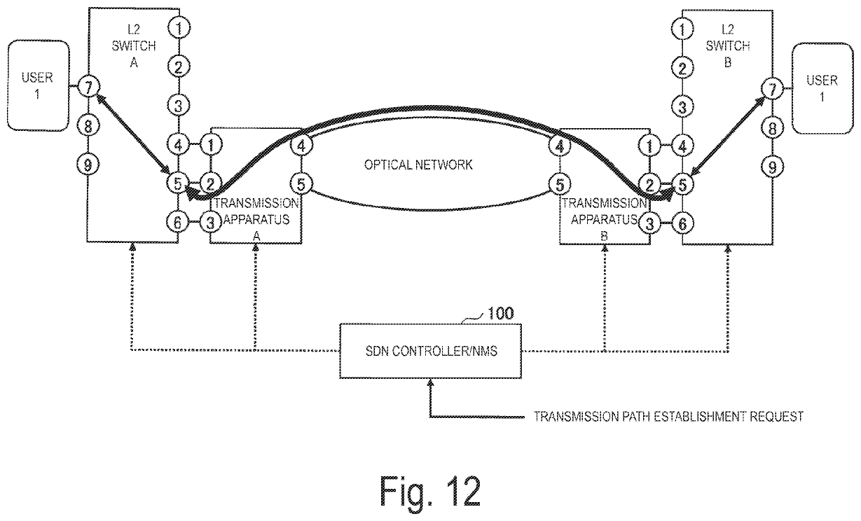

FIG. 12 is a diagram illustrating an example of a configuration of a transmission path according to the second embodiment of the present invention. When establishing the transmission path, the SDN controller/NMS 100 establishes, between the transmission apparatus A and the transmission apparatus B, a transmission path satisfying a requirement (transmission restoration/no redundancy) for a redundant configuration in the transmission layer. For example, when the transmission restoration is required, a light wavelength path (light wavelength path ID=1) using a wavelength λ1 for which the transmission restoration is configured is established between a physical port 4 of the transmission apparatus A and a physical port 4 of the transmission apparatus B.

Physical wiring information and port information between the L2 switch and the transmission apparatus are assumed to be registered in the SDN controller/NMS 100. Furthermore, the connection relationship in the transmission apparatus is assumed to be also registered in the SDN controller/NMS 100. Thus, upon establishing the light wavelength path (light wavelength path ID=1) using the wavelength λ1 as described above, the SDN controller/NMS 100 can recognize that the port 5 of the L2 switch A is an end point of the light wavelength path with the transmission restoration.

The SDN controller/NMS 100 configures a transmission path on the network according to the redundant configuration of the transmission path, and associates the connection port of the user at the L2 switch, with a port of the L2 switch serving as the end point of the transmission path thus configured. In the example described in the present embodiment, Virtual Local Area Network (VLAN) is used for the association, but the present embodiment is also applicable to a case where other techniques are used, as long as the communications using the connection port can be performed over the transmission path. When the transmission restoration is required as the redundant configuration, the SDN controller/NMS 100 establishes the light wavelength path (light wavelength path ID=1) as described above, and, when the transmission path is established, makes the connection port (ports 7 of the L2 switches A and B) for the user and the end point (ports 5 of the L2 switches A and B) of the transmission path belong to the same VLAN.

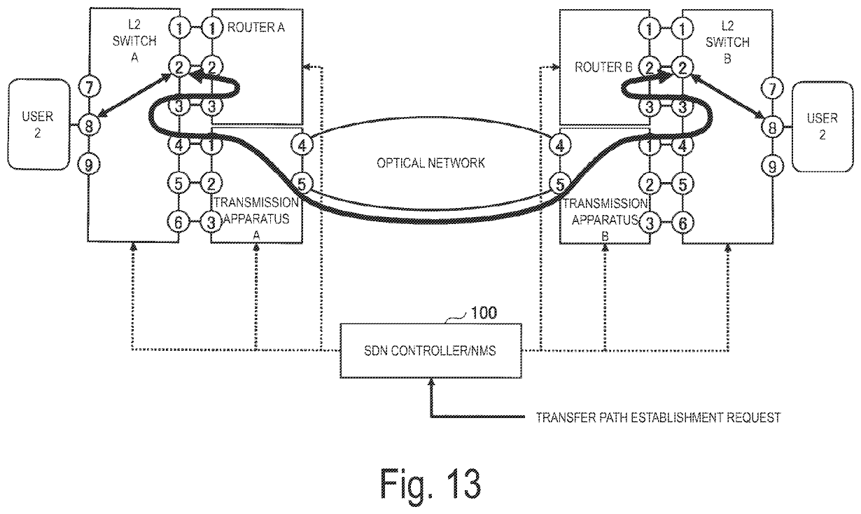

FIG. 13 is a diagram illustrating an example of a configuration of a transfer path according to the second embodiment of the present invention. When establishing the transfer path, the SDN controller/NMS 100 establishes, between the routers A and B via the transmission apparatuses A and B, a transfer path satisfying a requirement (transfer protection/no redundancy) for a redundant configuration in the transfer layer. For example, when the redundant configuration is not required, the SDN controller/NMS 100 establishes a light wavelength path (light wavelength path ID=3) using a wavelength λ3 for which the transmission restoration is not configured between the physical port 5 of the transmission apparatus A and the physical port 5 of the transmission apparatus B. Then, the SDN controller/NMS 100 configures, between the physical port 3 of the router A and the physical port 3 of the router B, a transfer path (VPN) of a single route on the light wavelength path using the wavelength λ3 via the L2 switches A and B. When the transfer protection is required but the transmission restoration is not required, the SDN controller/NMS 100 may similarly establish the light wavelength path (light wavelength path ID=3) using a wavelength λ3 for which the transmission restoration is not configured, and configure the transfer path of two routes between the routers.

Physical wiring information and port information between the L2 switch/router/transmission apparatuses are assumed to be registered in the SDN controller/NMS 100. Furthermore, the connection relationship in the router and in the transmission apparatus is assumed to be also registered in the SDN controller/NMS 100. Thus, upon establishing the transfer path (VPN) without the redundant configuration as described above, the SDN controller/NMS 100 can recognize that the port 2 of the L2 switch A is an end point of the transfer path without the redundant configuration.

The SDN controller/NMS 100 configures a transfer path on the network according to the redundant configuration of the transfer path, and associates the connection port of the user at the L2 switch, with a port of the L2 switch serving as the end point of the transfer path thus configured. When the redundant configuration is not required, the SDN controller/NMS 100 establishes the transfer path of a single route on the light wavelength path (light wavelength path ID=3) as described above, and, when the transfer path is established, makes the connection port (a port 8 of the L2 switches A and B) for the user and the end point (ports 2 of the L2 switches A and B) of the transfer path belong to the same VLAN.

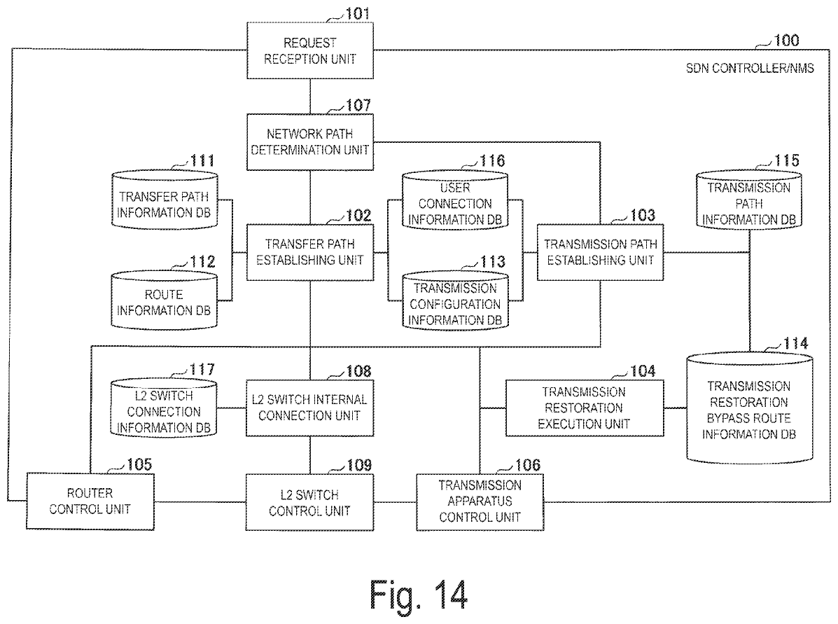

FIG. 14 is a block diagram illustrating a configuration of an SDN controller/NMS 100 according to the second embodiment of the present invention. The SDN controller/NMS 100 further includes, as functional units in addition to those in the first embodiment, a network path determination unit 107, an L2 switch internal connection unit 108, and an L2 switch control unit 109. The SDN controller/NMS 100 further includes, as storage units, a transmission path information DB 115, a user connection information DB 116, and an L2 switch connection information DB 117. Hereinafter, differences from the first embodiment will be described.

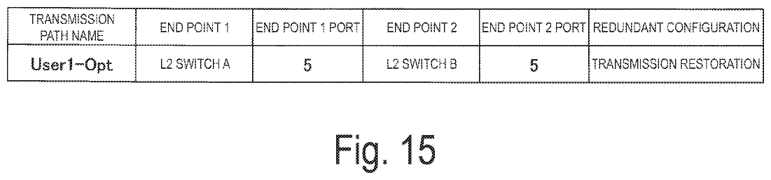

The transmission path information DB 115 is a storage unit that manages a transmission path configured in response to an establishment request from the user. In the transmission path information DB 115, information on an end point of a transmission path established by the transmission path establishing unit 103 as described later is registered. For example, when the transmission path for which the transmission restoration for the transmission apparatuses A and B is configured is established between the L2 switches A and B in the illustrated in FIG. 12, the transmission path information DB 115 holds the information as illustrated in FIG. 15.

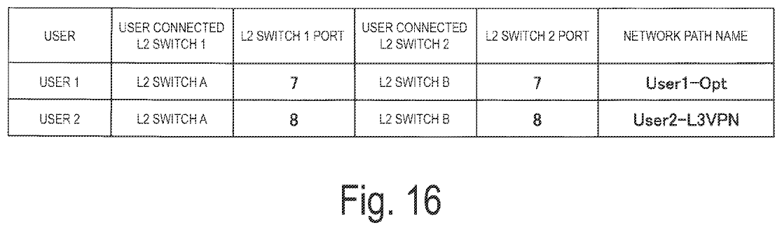

The user connection information DB 116 is a storage unit that manages connection information on the user side of a network path (transmission path and transfer path) configured in response to the establishment request from the user. The user connection information DB 116 holds information on the user side port of the L2 switch in a format illustrated in FIG. 16 for the transmission path established by the transmission path establishing unit 103 and the transfer path established by the transfer path establishing unit 102.

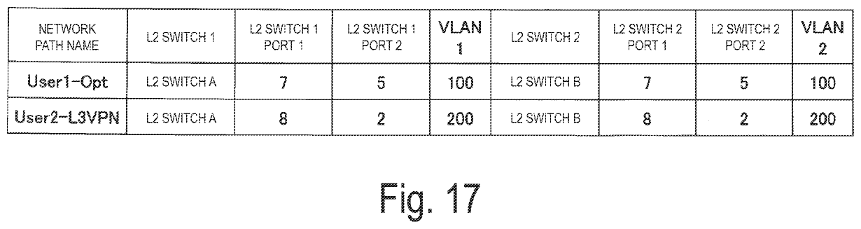

The L2 switch connection information DB 117 is a storage unit that manages information on the FLAN configured in the L2 switch, The L2 switch connection information DB 117 holds information on the VLAN in the L2 switch established by the L2 switch internal connection unit 108, as described later, in a format illustrated in FIG. 17.

The request reception unit 101 receives an establishment request including a requirement for a redundant configuration (transfer protection/transmission restoration/no redundancy) for the network path from the user. The request may be issued from the outside of the SDN controller/NMS 100 or may be a request as a result of calculation by an algorithm configured in the SDN controller/NMS 100 in advance. The establishment request is assumed to include the connection point of the user and a condition (redundant configuration) required for establishing the network path.

The network path determination unit 107 determines whether the network path requested is a transmission path or a transfer path. When the network path is a transfer path, a transfer path establishment request is issued such that the transfer path establishing unit 102 establishes the transfer path. When the network path is a transmission path, a transmission path establishment request is issued such that the transmission path establishing unit 103 establishes the transmission path. In a case where a transfer protection is required as a requirement for the redundant configuration, the network path determination unit 107 needs to request the transfer path establishing unit 102 to establish a transfer path for which the transfer protection is configured. In a case where redundant configuration is required as a requirement for the redundant configuration, the network path determination unit 107 needs to request the transmission path establishing unit 103 to establish a transmission path for which the redundant configuration is configured.

The transfer path establishing unit 102 generates the transfer path information in response to the transfer path establishment request, registers the information in the transfer path information DB 111 as in the first embodiment, and registers the information in the user connection information DB 116. The information on the transfer path that can be established may be calculated by an algorithm inside the SDN controller/NMS 100 or may be provided from the outside. For example, when the transfer path with no redundancy is required from the user 2, as illustrated in FIG. 13, a transfer path having only a single route is established between the routers A and B via the transmission apparatuses A and B (on the light wavelength path (light wavelength path ID=3)). When a transfer path for which the transfer protection is configured is required, a transfer path having two routes is established between the routers A and B.

Upon establishing the transfer path, the transfer path establishing unit 102 registers the information in the transfer path information DB 111 as well as in the user connection information DB 116, and configures the transfer path for the routers at the starting point and the ending point via the router control unit 105. The configuration may be input to the routers using an open API such as Netconf or using a protocol unique to the routers.

The transmission path establishing unit 103 generates the transmission path information in response to the transmission path establishment request, registers the information in the transmission configuration information DB 113 as in the first embodiment, and registers the information in the transmission path information DB 115 and the user connection information DB 116. The information on the transmission path that can be established may be calculated by an algorithm inside the SDN controller/NMS 100 or may be provided from the outside. For example, when the user 1 requires a transmission path for which the transmission restoration is configured, the transmission path establishing unit 103 establishes the transmission path for which the transmission restoration is configured between the physical ports 4 of the transmission apparatuses A and B as illustrated in FIG. 12.

Upon establishing the transmission path, the transmission path establishing unit 103 registers the information in the transmission configuration information DB 113 as well as the transmission path information DB 115 and the user connection information DB 116, and inputs the configuration to the transmission apparatuses via the transmission apparatus control unit 106 to establish the transmission path. The configuration may be input to the transmission apparatuses using an open API such as Netconf or using a protocol unique to the transmission apparatuses.

The L2 switch internal connection unit 108 connects the connection point of the user with a port of the L2 switch at end points of the established network path (transfer path or transfer path), in the L2 switches that are the starting point and the ending point connected to the users. Specifically, the L2 switch internal connection unit 108 acquires, from the user connection information DB 116 or the transmission path information DB 115, the user connection port information and the network path end point port information on the L2 switch each linked to the network path established by the transfer path establishing unit 102 or the transmission path establishing unit 103, and registers the information in the L2 switch connection information DB 117. VLAN information (VLAN1, VLAN2) in the L2 switch connection information DB may be automatically set using vacant VLAN number or may be statically set by a controller. The L2 switch internal connection unit 108 enables communications to be performed between the L2 switch ports of each of the L2 switches at end points of the network path and the connection port for the user via the L2 switch control unit 109, based on the information registered in the L2 switch connection information DB 117. A method of achieving establishment between the ports of the L2 switch is not limited to ULAN, and routing, Virtual eXtensible Local Area Network (VXLAN), or the like may be used. The configuration may be input to the L2 switch using an open API such as Netconf or using a protocol unique to the L2 switch.

As described above, in a communication network using the L2 switch, end points of the transmission path (wavelength occupying dedicated line) and the transfer path (L2VPN/L3VPN) are accommodated in the same L2 switch, and the user connection point is also set to be the same L2 switch. Under this condition, the controller performs control so that communications can be performed between the port of the L2 switch used at the end point of the transfer path or the transmission path and the port of the L2 switch as the connection point of the user. Thus, the transmission path and the transfer path under various conditions can be provided using the same connection point.

### Third Embodiment

A third embodiment aims to shorten the communication disconnection during the transmission restoration according to the first and second embodiments. Specifically, a method is described including: temporarily handing over the traffic on the transfer path or the transmission path using the target wavelength, to an established transfer path or transmission path; and once the transmission restoration is completed, again handing over the traffic to a bypass route capable of the transmission restoration.

The transmission restoration is a technique of restoring, when a transmission path fails, the transmission path through wavelength route switching by transmission apparatuses. Unfortunately, the control on the transmission apparatuses generally takes a certain amount of time, resulting in a long communication disconnection until the restoration, compared with the transfer protection. Until the wavelength route switching by transmission apparatuses is completed, the user traffic is temporarily handed over to the established transfer path or transmission path. Once the wavelength route switching is completed, the user traffic is again handed over to the transmission path after the route switching. Thus, the communication disconnection during the transmission restoration can be shortened. In the following description, the established transfer path or transmission path temporarily used is referred to as a temporary bypass path, and the transmission path after the route switching is referred to as a bypass path.

The temporary bypass path may be established as a dedicated path for this purpose, or an existing path used by another user may be also used for this purpose. The temporary bypass path may be determined by selecting an available path in a contract bandwidth of the transmission path that is the target of the transmission restoration, or may be selected by a different logic.

A diagram illustrating a block configuration of the SDN controller/NMS 100 according to the third embodiment is the same as those according to the first and second embodiments respectively illustrated in FIG. 6 and FIG. 14.

First of all, processing executed by the functional units of the SDN controller/NMS 100 according to the third embodiment will be described with reference to FIG. 6 which is the block diagram illustrating the configuration according to the first embodiment.

Upon receiving a port down alert from a transmission apparatus due to a failure that has occurred between the transmission apparatuses, the transmission restoration execution unit 104 searches the transmission configuration information DB 113 for a wavelength using the port for which the alert has been received, and identifies the wavelength. For example, when a failure occurs between the physical port 4 of the transmission apparatus A and the physical port 4 of the transmission apparatus B, the wavelength (λ1, λ2) utilizing the physical port 4 of the transmission apparatus A and the physical port 4 of the transmission apparatus B is extracted from the transmission configuration information DB 113. The route of the wavelength λ2 is not switched to the bypass path because transmission restoration control is disabled. The transmission restoration execution unit 104 extracts the light wavelength path ID=1 corresponding to the wavelength (λ1) for which the restoration control is enabled from the extracted wavelengths. Furthermore, a Segment list (A-to-B-1 and B-to-A-1) affected by the light wavelength path ID=1 and the transfer path (VPN1) using the Segment list are extracted from the route information DB 112. When there is another established light wavelength path with the starting point/ending point matching that of the light wavelength path ID=1, the transmission restoration execution unit 104 uses the established light wavelength path as the temporary bypass path for the light wavelength path ID=1. When there is another established transfer path with the starting point/ending points matching those of the transfer path (VPN1), the transmission restoration execution unit 104 may use the established transfer path as the temporary bypass path for the transfer path (VPN1). The transmission restoration execution unit 104 uses the temporary bypass path in place for the affected transfer path or transmission path, until the wavelength route switching for the light wavelength path ID=1 is completed. Then, the transmission restoration execution unit 104 searches the transmission restoration bypass route information DB 114 in FIG. 10 for a bypass path. Based on this information, the transmission restoration execution unit 104 causes the transmission apparatus control unit 106 to control the transmission apparatuses to perform the wavelength route switching to the bypass path. Once the wavelength route switching to the bypass path is completed, the transmission restoration execution unit 104 again hands over the traffic on the temporary bypass path to the bypass path as a result of the wavelength route switching completed.

First of all, processing executed by the functional units of the SDN controller/NMS 100 according to the third embodiment will be described with reference to FIG. 14 which is the block diagram illustrating the configuration according to the second embodiment.

Upon receiving a port down alert from a transmission apparatus due to a failure that has occurred between the transmission apparatuses, the transmission restoration execution unit 104 identifies the transfer path or the transfer path that is affected by the alert as described above. When the restoration control for the wavelength of the transfer path or the transmission path identified is enabled, the temporary bypass path is used in place for the transfer path or the transmission path affected until the wavelength route switching is completed, and rerouting is performed from the temporary bypass path to the bypass path when the wavelength route switching is completed.

When the transmission restoration execution unit 104 uses the temporary bypass path in place for the transfer path or the transmission path as described above, the L2 switch internal connection unit 108 makes an end point of the temporary bypass path connected to the connection point of the user. Specifically, when the transmission restoration execution unit 104 selects the temporary bypass path which is used inplace for the transfer path or the transmission path that is the target of the transmission restoration, the L2 switch internal connection unit 108 refers to the L2 switch connection information DB 117 to identify the port of the L2 switch serving as an end point of the transfer path or the transmission path. The L2 switch internal connection unit 108 refers to the L2 switch connection information DB 117 also for identifying the port of the L2 switch serving as an end point of the temporary bypass path. The L2 switch internal connection unit 108 connects the port of the L2 switch serving as the end point of the temporary bypass path to the connection port of the user.

Furthermore, when the transmission restoration execution unit 104 reroutes from the temporary bypass path to the bypass path as described above, the L2 switch internal connection unit 108 makes an end point of the bypass path connected to the connection point of the user. Specifically, when the transmission restoration execution unit 104 selects the bypass path with which the transmission path that is the target of the transmission restoration is bypassed, the L2 switch internal connection unit 108 refers to the L2 switch connection information DB 117 to identify the port of the L2 switch serving as an end point of the bypass path. The L2 switch internal connection unit 108 relinks the port of the L2 switch serving as the end point of the temporary bypass path connected to the connection port of the user, to the port of the L2 switch serving as the end point of the bypass path.

### Example of Hardware Configuration

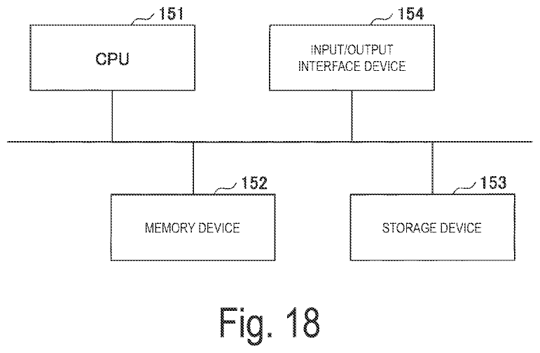

FIG. 18 illustrates a hardware configuration example of the SDN controller/NMS 100 according to the embodiment of the present invention. The SDN controller/NMS 100 may be a computer including a processor, such as a Central Processing Unit (CPU) 151, a memory device 152, such as a Random Access Memory (RAM) and a Read Only Memory (ROM), a storage device 153, such as a hard disk, or the like. For example, functions and processing of the SDN controller/NMS 100 are realized by the CPU 151 executing data and programs stored in the storage device 153 or the memory device 152. Also, data input to the SDN controller/NMS 100 may be performed from an input/output interface device 154, and data output from the SDN controller/NMS 100 may be performed from the input/output interface device 154.

### Supplements

Although the path selection apparatus according to the embodiment of the present invention has been described using the functional block diagram for convenience of description, the path selection apparatus according to the embodiment of the present invention may be realized by hardware, software, or a combination thereof For example, embodiments of the present invention may be realized by a program for causing a computer to achieve the functions of the path selection apparatus according to the embodiments of the present invention, a program for causing a computer to execute the respective steps of the method according to the embodiments of the present invention, or the like. Further, respective functional units may be used in combination, as necessary. Further, the method according to the embodiment of the present invention may be performed in an order different from the order shown in the embodiments.

Although the method for providing a transfer path in a transfer layer satisfying more reliability requirements by making a redundant configuration in a transmission layer applicable to the transfer path has been described above, the present invention is not limited to the above embodiments, and various changes and applications are possible within the scope of the claims.

### REFERENCE SIGNS LIST

100 SDN controller/NMS
101 Request reception unit
102 Transfer path establishing unit
103 Transmission path establishing unit
104 Transmission restoration execution unit
105 Router control unit
106 Transmission apparatus control unit
107 Network path determination unit
108 L2 switch internal connection unit
109 L2 switch control unit
111 Transfer path information DB
112 Route information DB
113 Transmission configuration information DB
114 Transmission restoration bypass route information DB
115 Transmission path information DB
116 User connection information DB
117 L2 Switch connection information DB

1. A control device used in a communication network including a plurality of routers and a plurality of transmission apparatuses configured to connect the plurality of routers to each other, the control device comprising:
a transmission configuration information storage unit, including one or more processors, configured to manage a transmission path that connects the plurality of transmission apparatuses to each other, and to determine whether a redundant configuration in a transmission layer is available for the transmission path;
a route information storage unit, including one or more processors, configured to manage a route configured between the plurality of routers and a transmission path used on the route; and
a transfer path establishing unit, including one or more processors, configured to, in response to an establishment request including a requirement for the redundant configuration for a transfer path connecting the plurality of routers to each other, refer to the transmission configuration information storage unit and the route information storage unit, establish a transfer path using a redundant route when a redundant configuration in a transfer layer is required as the requirement in the redundant configuration, and establish a transfer path not using the redundant route but being linked to the transmission path with the redundant configuration in the transmission layer when the redundant configuration in the transmission layer is required as the requirement for the redundant configuration.

2. The control device according to claim 1, wherein the transmission path establishing unit is further configured to establish a transmission path that connects the plurality of transmission apparatus to each other, and to register whether the redundant configuration in the transmission layer is available for the transmission path, in the transmission configuration information storage unit.

3. The control device according to claim 1, further comprising a bypass execution unit, including one or more processors, configured to: identify, upon receiving an alert from at least one of the plurality of transmission apparatuses, a transfer path or a transmission path affected by the alert, and when the redundant configuration in the transmission layer is available for the transfer path or the transmission path, use a temporary bypass path in place for the transfer path or the transmission path until bypass processing of bypassing the transfer path or the transmission path with a bypass path in the transmission layer is completed, and to reroute from the temporary bypass path to the bypass path once the bypass processing of bypassing the transfer path or the transmission path with the bypass path is completed.

4. The control device according to claim 2, wherein
the communication network further comprises a starting point layer 2 switch and an ending point layer 2 switch to which a user is connected,
the starting point layer 2 switch and the ending point layer 2 switch are connected to any of the plurality of routers and any of the plurality of transmission apparatuses, and
the control device further comprises:
a network path determination unit, including one or more processors, configured to, in response to an establishment request including a requirement for a redundant configuration from the user, issue an establishment request for establishing a transfer path with a redundant configuration in a transfer layer to the transfer path establishing unit when the redundant configuration in the transfer layer is required as a requirement for the redundant configuration, and issue an establishment request for establishing a transmission path with a redundant configuration in the transmission layer to the transmission path establishing unit when the redundant configuration in the transmission layer is required as the requirement for the redundant configuration; and
a layer 2 switch internal connection unit, including one or more processors, configured to connect an end point of the established transfer path or the transmission path with a connection point of the user in the starting point layer 2 switch and the ending point layer 2 switch.

5. The control device according to claim 4 further comprising a bypass execution unit, including one or more processors, configured to identify, upon receiving an alert from the transmission apparatuses, a transfer path or a transmission path affected by the alert, and when the redundant configuration in the transmission layer is available for the transfer path or the transmission path, use a temporary bypass path in place for the transfer path or the transmission path temporarily until bypass processing of bypassing the transfer path or the transmission path with a bypass path in the transmission layer is completed, and to reroute from the temporary bypass path to the bypass path once the bypass processing of bypassing the transfer path or the transmission path with the bypass path is completed, wherein the layer 2 switch internal connection unit is configured to connect an end point to the connection point of the user when the temporary bypass path is used in place for the transfer path or the transmission path, and to connect an end point of the bypass path to the connection point of the user when rerouting is performed from the temporary bypass path to the bypass path.

6. A control method performed by a control device used in a communication network including a plurality of routers and a plurality of transmission apparatuses configured to connect to the plurality of routers to each other, the control method comprising:
managing, by a transmission configuration information storage unit, a transmission path that connects the plurality of transmission apparatuses to each other, and whether a redundant configuration in a transmission layer is available for the transmission path;
managing, by a route information storage unit, a route configured between the routers and a transmission path used on the route; and
in response to an establishment request including a requirement for the redundant configuration for a transfer path connecting the plurality of routers to each other, referring to the transmission configuration information storage unit and the route information storage unit, establishing a transfer path using a redundant route when a redundant configuration in a transfer layer is required as the requirement in the redundant configuration, and establishing a transfer path not using the redundant route but being linked to the transmission path with the redundant configuration in the transmission layer when the redundant configuration in the transmission layer is required as the requirement for the redundant configuration.

7. The control method according to claim 6, establishing a transmission path that connects the plurality of transmission apparatus to each other, and registering whether the redundant configuration in the transmission layer is available for the transmission path, in the transmission configuration information storage unit.

8. The control method according to claim 6, identifying, upon receiving an alert from at least one of the plurality of transmission apparatuses, a transfer path or a transmission path affected by the alert, when the redundant configuration in the transmission layer is available for the transfer path or the transmission path, use a temporary bypass path in place for the transfer path or the transmission path until bypass processing of bypassing the transfer path or the transmission path with a bypass path in the transmission layer is completed, and rerouting from the temporary bypass path to the bypass path once the bypass processing of bypassing the transfer path or the transmission path with the bypass path is completed.

9. The control method according to claim 7, further comprising, connecting a user to a starting point layer 2 switch and an ending point layer 2 switch, wherein, the starting point layer 2 switch and the ending point layer 2 switch are connected to any of the plurality of routers and any of the plurality of transmission apparatuses;
issuing, by a network path determination unit configured to in response to an establishment request including a requirement for a redundant configuration from the user, an establishment request for establishing a transfer path with a redundant configuration in a transfer layer to the transfer path establishing unit when the redundant configuration in the transfer layer is required as a requirement for the redundant configuration, and issuing an establishment request for establishing a transmission path with a redundant configuration in the transmission layer to the transmission path establishing unit when the redundant configuration in the transmission layer is required as the requirement for the redundant configuration; and
connecting, by a layer 2 switch internal connection unit, an end point of the established transfer path or the transmission path with a connection point of the user in the starting point layer 2 switch and the ending point layer 2 switch.

10. The control method according to claim 9 further comprising, identifying, by a bypass execution unit, upon receiving an alert from the transmission apparatuses, a transfer path or a transmission path affected by the alert, and when the redundant configuration in the transmission layer is available for the transfer path or the transmission path, using a temporary bypass path in place for the transfer path or the transmission path temporarily until bypass processing of bypassing the transfer path or the transmission path with a bypass path in the transmission layer is completed, and rerouting from the temporary bypass path to the bypass path once the bypass processing of bypassing the transfer path or the transmission path with the bypass path is completed, wherein, connecting by the layer 2 switch internal connection unit an end point to the connection point of the user when the temporary bypass path is used in place for the transfer path or the transmission path, and connecting an end point of the bypass path to the connection point of the user when rerouting is performed from the temporary bypass path to the bypass path.
